(19) United States
(12) Patent Application Publication
(10) Pub. No.: US 2024/0313265 A1
(43) Pub. Date: Sep. 19, 2024

(54) METHOD FOR PRODUCING A SOLID-STATE BATTERY CELL

(71) Applicant: Volkswagen Aktiengesellschaft, Wolfsburg (DE)

(72) Inventors: Stephan Leonhard KOCH, Koenigslutter (DE); Miriam KUNZE, Seelze (DE); Tobias JANSEN, Braunschweig (DE)

(73) Assignee: Volkswagen Aktiengesellschaft, Wolfsburg (DE)

(21) Appl. No.: 18/607,462

(22) Filed: Mar. 16, 2024

(30) Foreign Application Priority Data
Mar. 16, 2023 (DE) 10 2023 202 370.9

(51) Int. Cl. H01M 10/058; H01M 10/0562; H01M 50/403

(52) U.S. Cl. CPC H01M 10/058; H01M 10/0562; H01M 50/403; H01M 2300/0065

(57) ABSTRACT

A method for producing a solid-state battery cell. A starting material is provided for a separator material in the form of a layer. The layer is at least partially coated with a sublimable coating material and forms a separator material coated with a coating.

This nonprovisional application claims priority under 35 U.S.C. § 119(a) to German Patent Application No. 10 2023 202 370.9, which was filed in Germany on Mar. 16, 2023, and which is herein incorporated by reference.

### BACKGROUND OF THE INVENTION

### Field of the Invention

The present invention relates to a method for producing a solid-state battery cell. The method relates in particular to the production of a separator material that is then used in a solid-state battery cell.

### Description of the Background Art

Batteries, in particular lithium-ion batteries, are increasingly used for driving motor vehicles. In particular, a motor vehicle, for example, has an electric machine for driving the motor vehicle, wherein the electric machine can be driven by the electrical energy stored in the battery cell. Batteries are normally assembled from battery cells, wherein each battery cell has a stack of anode, cathode, and separator sheets. At least a portion of the anode and cathode sheets are implemented as current collectors for conducting the current provided by the cell to a load arranged outside the cell. Battery cells with liquid or solid electrolytes (solid-state battery) are known.

A solid-state battery cell includes, in particular, a housing of gas-tight construction and, arranged therein, at least one stack of electrodes or layers arranged one on top of the other. The housing can be implemented as a rigid housing (prismatic cell) or be implemented at least partially from an elastically deformable film material (pouch cell). A combination of the two housing types is also possible.

The separator material is used in an all-solid-state battery cell (solid-state battery cell), which, in other words, comprises exclusively solid components (semisolid electrolytes included, e.g., polymers), thus also a solid electrolyte. These solid electrolytes are arranged between the electrodes (anode, cathode) as ion-conducting separator materials. These separator materials can be normally formed of ceramic materials or polymer, glass, or hybrid materials.

Separators made of ion-conducting solid-state electrolytes have a marked instability, in particular with respect to atmospheric humidity and atmospheric oxygen. Moreover, a significant portion of the ions or of the lithium evaporates from the material within the framework of the sintering process or the production of, e.g., the ion-conducting solid-state electrolyte. Both of these, lithium evaporation and the reaction with atmospheric constituents, reduce the ion or lithium conductivity and thus the performance of the separator material or the separator membrane for solid-state battery cells.

Moreover, it is normally intended that the lithium anode in the solid-state battery cell forms in situ in the first charge cycle of the battery cell (which is to day during forming). To this end, it is necessary in particular that certain features are present at the surface of the separator material so that the deposition required for this purpose works.

Until now, contact of the separator material with atmospheric humidity or atmospheric oxygen is prevented through the use of an inert atmosphere. The provision and maintenance of such an inert atmosphere is very resource-intensive, however.

From GB 1 189 222 A1, which corresponds to U.S. Pat. No. 3,607,433, a method is known for producing an electrode for a battery cell. Here, a solid electrolyte body is produced and coated with an electrode material.

From WO 2004/067259 A1, which corresponds to US 2004/0142101, a production method for fuel cells is known.

### SUMMARY OF THE INVENTION

It is therefore an object of the present invention to at least partially solve the problems stated with reference to the prior art. In particular, the aim is to propose a method by means of which the production of a solid-state battery cell is possible at lower cost.

A method for producing a solid-state battery cell is thus proposed. The method has at least the following steps:
a) providing a starting material for a separator material in the form of a layer; and
b) at least partially coating the layer with a sublimable coating material, and forming a separator material coated with a coating.

The above (not definitive) division of the method steps into a) and b) is intended primarily to serve only purposes of differentiation, and not to enforce any sequence and/or dependency. The frequency of the method steps can also vary. It is likewise possible that method steps can at least partially overlap one another in time. Preferably, the steps a) and b) are performed in the stated sequence.

The coated separator material produced in steps a) and b) is intended, in particular, for use in a lithium-ion battery cell or a lithium metal battery cell and as appropriate also for sodium or aluminum battery cells.

The separator material is used in an all-solid-state battery cell (solid-state battery cell), which, in other words, comprises exclusively solid components (semisolid electrolytes included, e.g., polymers), thus also a solid electrolyte. These solid electrolytes are arranged between the electrodes as ion-conducting separator materials and/or are already contained in the active material or mixed therewith as an electrolyte. These separator materials normally formed of ceramic materials or polymer, glass, or hybrid materials.

In particular, an additional step a1), in which the layer is sintered after step a), is provided between the steps a) and b). This process step is provided for ceramic separator materials, in particular. Step b), in particular, then follows after step a1).

The lithium-ion-conducting starting material for use as separator material (or as electrolyte in the anode layer or cathode layer) can include at least one of the following materials from the material class of sulfides, oxides, nitrides, halides, hydrides, or polymers. The following are mentioned by way of example for this purpose: thio-LISICON-type materials (Li₂S—P₂S₅, Li₂S—SiS₂, Li₂S—GeS₂), argyrodites (Li₆PS₅X (where X═Cl, Br, or I), Li₇PS₆, Li₇PSe₆), garnets (Li₂La₃Zr₂O₁₂ (LLZO)), perovskites (Li₃ₓLa_{2/3-3x}TiO₃ (LLTO)); NASICON-type materials (Li₁₊ₓAlₓTi₂₋ₓ(PO₄)₃, Li_{1.5}Al_{0.5}Ge_{1.5}(PO₄)₃,), halides (Li2CdCl4), nitrides (Li3N, Li2PN4), hydrides (Li₂NH, LiBH₄), polymers (PEO-LiTFSI, phophazene-LiTFSI, PEO-LiFSI). In particular, combinations of the said materials are also possible.

The electrode includes, in particular, a carrier material, for example a copper or aluminum foil. The carrier material used can include, in particular, copper that is 3 to 15 μm thick for the anode and aluminum that is 3 to 15 μm [micrometers] thick for the cathode. The carrier material is at least partially coated with an active material, at least on one largest lateral surface, if applicable also on the mutually opposite largest lateral surfaces. The carrier material is implemented as continuous material.

Within the framework of step a), a providing of a starting material for a separator material in the form of a layer takes place, in particular. The layer is, for example, a filmlike or planar body that, in particular, is designed in the shape of a rectangular solid, but with a small material thickness. In this design, the body has two opposite largest lateral surfaces and significantly smaller other lateral surfaces or edges of the layer.

Within the framework of step b), an at least partial (or complete) coating of the layer with a sublimable coating material and a forming of a separator material coated with a coating takes place, in particular. Sublimable means, for example, that the coating material transitions directly into the gaseous state from the solid state after application to the separator material.

This transition should take place at ambient conditions, in particular, which are not harmful for the other components of the battery cell.

The coating can be applied by a variety of coating methods, for example by spraying, dipping, laminating, etc.

In particular, the layer is a planar body whose two largest, mutually opposite lateral surfaces are completely coated in step b). In particular, all lateral surfaces are fully coated, which is to say the entire body is fully coated.

In particular, the coating can be impermeable at least to H₂O and/or CO₂. Impermeable means that contact between the separator material and the said molecules should be prevented by the coating or should be impossible through the coating material.

In particular, the coating material at least partially includes camphor (C₁₀H₁₆O), also referred to as bornan-2-one or 1,7,7-Trimethyl-bicyclo[2.2.1]heptan-2-one, or preferably is made completely thereof.

Camphor sublimates at temperatures as low as room temperature, and as a coating is impermeable at least to H₂O and/or CO₂.

However, other coating materials that have comparable properties can also be used.

In particular, the coating material can be sublimed and at least partially (or completely) removed from the separator material in a step c), in particular subsequent to step b), at a temperature of at most 120 degrees Celsius, preferably of at most 100 degrees Celsius, and at a pressure of less than 250 millibar, in particular at a pressure of less than 150 millibar, preferably at a pressure of at most 100 millibar.

In particular, the coating material can be removed completely from the separator material in step c), preferably with the said process parameters.

In particular, the sublimed coating material can be collected and recycled after step c). In particular, the coating material can be reused almost without limit, preferably also for the method described.

In particular, the coated separator material can be arranged at least between two electrode materials between the steps b) and step c). Owing to the possible sublimation of the coating material, the removal of the coating material can also take place after a stacking of the components of a battery cell. In this process, the coating material can escape from the stack and be carried away, for example along the surfaces of the components resting on one another. Contact of the separator material with H₂O and/or CO₂ is prevented at this time, in particular by the contact of the previously coated surfaces with the other components (e.g., electrodes) of the stack.

In particular, the electrode materials that have been arranged in a stack and the coated separator material can be arranged in a housing of the battery cell between the steps b) and step c). The sublimed coating material can then in particular be removed through an opening in the housing.

In particular, the housing can be sealed after step c).

With the proposed method, it is possible in particular to reduce the costs for production of a battery cell because no separate inert gas atmosphere is necessary. Moreover, the shelf life of the separator material is improved or its aging is slowed.

In addition, a solid-state battery cell is proposed, comprising at least a housing of the battery cells and, arranged therein, at least two electrodes (an anode and a cathode) as well as at least one layer of the separator material that has been produced by the described method.

The solid-state battery cell is, for example, a pouch cell (with a deformable battery cell housing formed of a pouch film) or a prismatic cell (with a rigid battery cell housing). A pouch film is a known, deformable housing part that is used as a battery cell housing for so-called pouch cells. This is a composite material, for example comprising a plastic and aluminum.

The solid-state battery cell is, for example, a lithium-ion battery cell or a lithium metal battery cell.

A solid-state battery cell can be a power storage device that is used to store electrical energy, for example in a motor vehicle. In particular, a motor vehicle, for example, has an electric machine for driving the motor vehicle (a traction drive), wherein the electric machine can be driven by the electrical energy stored in the solid-state battery cell.

In addition, a motor vehicle is proposed, at least comprising a traction drive and a battery with at least one of the described solid-state battery cells, wherein the traction drive can be supplied with energy by the at least one solid-state battery cell.

In particular, at least one system for data processing is provided that has means that are suitably equipped, configured, or programmed to carry out the method or to control a device executing the method or that execute the method.

The means comprise, for example, a processor and a memory in which instructions to be executed by the processor are stored, as well as data lines or transmission devices that permit transmission of instructions, measured values, data, or the like, between the stated elements.

In addition, a computer program is proposed, comprising instructions that, when the program is executed by a computer, cause the latter to execute the described method or the steps of the described method.

In addition, a computer-readable storage medium is proposed, comprising instructions that, when executed by a computer, cause the latter to execute the described method or the steps of the described method.

The remarks concerning the method are applicable to the solid-state battery cell, the motor vehicle, the system for data processing, and/or the computer-implemented method (which is to say the computer program and the computer-readable storage medium), and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a sequence of the method;

FIG. 2 shows a layer of the separator material in a perspective view;

FIG. 3 shows a stack of electrodes and separator material in a housing of a battery cell in a side view in cross-section; and

FIG. 4 shows a battery cell.

### DETAILED DESCRIPTION

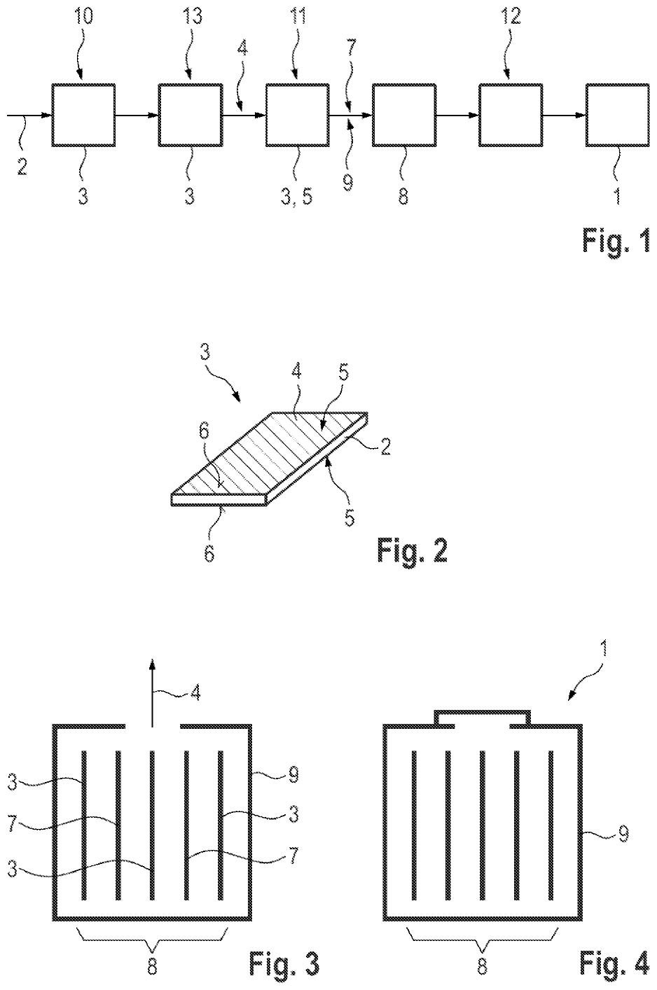

FIG. 1 shows a sequence of the method. A providing of a starting material for a separator material 2 in the form of a layer 3 takes place within the framework of step a) 10. The layer 3 is a filmlike or planar body that is designed in the shape of a rectangular solid, but with a small material thickness (see FIG. 2). In this design, the body has two opposite largest lateral surfaces 6 and significantly smaller other lateral surfaces or edges of the layer 3.

A sintering of the layer 3 takes place in a step a1) 13. Step b) 11 then follows after the step a1) 13. A complete coating of the layer 3 with a sublimable coating material 4 and a forming of a separator material 2 coated with a coating 5 takes place within the framework of step b) 11.

After step b) 11 and before step c) 12, the coated separator material 2 is arranged between two electrode materials 7 (an anode and a cathode). The electrode materials 7 that have been arranged in a stack 8 and the coated separator material 4 are arranged in a housing 9 of the battery cell 1.

Owing to the possible sublimation of the coating material 4, the removal of the coating material 4 can also take place after a stacking of the components 4, 7 of a battery cell 1. In this process, the coating material 4 can escape from the stack 8 and be carried away, for example along the surfaces of the components 4, 7 resting on one another. Contact of the separator material 2 with H₂O and/or CO₂ is prevented at this time by the contact of the previously coated surfaces of the separator material 4 with the other components (e.g., electrodes 7) of the stack 8.

In a step c) 12 subsequent to step b) 11, the coating material 4 is sublimed and completely removed from the separator material 4 at a temperature of at most 120 degrees Celsius and at a pressure of less than 250 millibar. The sublimed coating material 4 can be removed through an opening in the housing 9. The housing 9 can be sealed after step c) 12, so that a ready-to-use battery cell 1 is created.

FIG. 2 shows a layer 3 of the separator material 2 in a perspective view. The layer 3 is a filmlike or planar body that is designed in the shape of a rectangular solid, but with a small material thickness. In this design, the body has two opposite largest lateral surfaces 6 and significantly smaller other lateral surfaces or edges of the layer 3. At least the largest lateral surfaces 6 have the coating 5.

FIG. 3 shows a stack 8 of electrodes (electrode material 7) and separator material 2 in a housing 9 of a battery cell 1 in a side view in cross-section. After step b) 11 and before step c) 12, the coated separator material 4 is arranged between two electrode materials 7 (an anode and a cathode). The electrode materials 7 that have been arranged in a stack 8 and the coated separator material 4 are arranged in a housing 9 of the battery cell 1. In a step c) 12 subsequent to step b) 11, the coating material 4 is sublimed and completely removed from the separator material 4 at a temperature of at most 120 degrees Celsius and at a pressure of less than 250 millibar. The sublimed coating material 4 can be removed through an opening in the housing 9 (see arrow).

FIG. 4 shows a battery cell 1 with the sealed housing 9 and the stack 8 arranged therein.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for producing a solid-state battery cell, the method comprising:
a) providing a starting material for a separator material as a layer; and
b) at least partially coating the layer with a sublimable coating material and forming a separator material coated with a coating.

2. The method according to claim 1, wherein the layer is a planar body whose two largest, opposite lateral surfaces are completely coated in step b).

3. The method according to claim 1, wherein the coating produced in step b) is impermeable at least to H₂O or CO₂.

4. The method according to claim 1, wherein the coating material includes camphor (C₁₀H₁₆O).

5. The method according to claim 1, wherein the coating material is sublimed and at least partially removed from the separator material in a subsequent step c) at a temperature of at most 120 degrees Celsius and at a pressure of less than 250 millibar.

6. The method according to claim 5, wherein the coating material is removed completely from the layer in step c).

7. The method according to claim 5, wherein the sublimed coating material is collected and recycled after step c).

8. The method according to claim 5, wherein the coated separator material is arranged at least between two electrode materials between the steps b) and step c).

9. The method according to claim 8, wherein the electrode materials that have been arranged in a stack and the coated separator material are arranged in a housing of the battery cell between the steps b) and step c).

10. The method according to claim 9, wherein the housing is sealed after step c).
